(19) United States
(12) Patent Application Publication
(10) Pub. No.: US 2014/0049490 A1
(43) Pub. Date: Feb. 20, 2014

(54) TOUCH SENSING UNIT AND A LIQUID CRYSTAL DISPLAY PANEL WITH THE SAME

(71) Applicant: InnoLux Corporation, Miao-Li County (TW)

(72) Inventors: Hong-Ru GUO, Miao-Li County (TW); Cheng-Hsu CHOU, Miao-Li County (TW); Ming-Chun TSENG, Miao-Li County (TW)

(73) Assignee: InnoLux Corporation, Miao-Li County (TW)

(21) Appl. No.: 13/948,220

(22) Filed: Jul. 23, 2013

(30) Foreign Application Priority Data
Aug. 14, 2012 (TW) 101129332

(51) Int. Cl. G06F 3/041

(52) U.S. Cl. CPC G06F 3/041
USPC 345/173

(57) ABSTRACT

A touch sensing unit includes a detection electrode, a switch and a boosting and discharging unit. The detection electrode detects the touch from an external object. The switch is connected to the detection electrode for generating a touch voltage. The boosting and discharging unit is connected to the detection electrode and the switch for discharging the detection electrode or boosting the voltage of the detection electrode.

### BACKGROUND OF THE INVENTION

1. Field of the Invention

The present invention relates to technical field of touch panel and, more particularly, to a touch sensing unit and a liquid crystal display panel with the same.

2. Description of Related Art

FIG. 1 is a circuit diagram of a prior touch sensing device 100. The prior touch sensing device 100 is composed of a pre-charge transistor 110, a detection electrode 120, an amplifier transistor 130, a read transistor 140, a coupling capacitor 150, a pre-charge line 160, a coupling pulse line 170, and a read line 180.

The touch sensing device 100 is provided to generate a finger capacitor Cf between finger and the detection electrode 120 by a finger touching a glass surface or approaching the touch sensing device 100. Instead of being a real capacitance, the finger capacitor Cf is a sensitive capacitance existed between the finger and the detection electrode 120.

FIG. 2 is a schematic diagram showing the voltage sensed by the known touch sensing device 100, wherein n0 is the voltage on the coupling pulse line 170, n1 is the voltage on the detection electrode 120. The pre-charge transistor 110 is turned on so that the pre-charge line 160 sets the voltage of the detection electrode 120 to a pre-charge voltage (Vpre) via the pre-charge transistor 110, or the pre-charge transistor 110 is turned on for discharging the detection electrode 120 before proceeding with sensing.

The pre-charge transistor 110 and the amplifier transistor 130 are turned off so as to generate a pulse with an amplitude Va when proceeding with sensing. Due to the pre-charge transistor 110 and the amplifier transistor 130 both being turned off and the coupling effect of the coupling capacitor 150, a pulse with an amplitude Va is generated on the detection electrode 120. When no finger touches a glass surface or approaches the detection sensing device 100, the voltage on the detection electrode 120 is close to the voltage on the coupling pulse line 170. Simultaneously, the voltage Va on the detection electrode 120 is (Vgh−Vgl)*{(Cc+Cs2)/(Cc+Cs1+Cs2)}+Vpre, in which Vgh is a pulse with a high potential, Vgl is a pulse with a low potential, Vpre is a voltage level of the pre-charge voltage, Cc is a capacitance value of the coupling capacitor 150, Cf is a capacitance value of the finger capacitor, Cs1 is a capacitance value of the pre-charge transistor 110, and Cs2 is a capacitance value of the amplifier transistor 130.

When the finger touches a glass surface or approaches the detection sensing device 100, it generates a finger capacitor Cf between the finger and the detection electrode 120. Due to the presence of finger capacitor Cf, it discharges the voltage on the detection electrode 120. At the same time, the voltage Va′ on the detection electrode 120 is (Vgh−Vgl)*{(Cc+Cs2)/(Cc+Cs1+Cs2+Cf)}+Vpre.

Therefore, the voltage difference dVet between the sensed voltage without finger touching and the sensed voltage with finger touching is:

dVet=Va−Va′=(Vgh−Vgl)*{Cf*(Cc+Cs2)/[(Cc+Cs1+Cs2+Cf)*(Cc+Cs1+Cs2)]}. (1)

FIG. 3 is a schematic diagram of the simulation of the voltage sensed by the prior touch sensing device 100. When the capacitance value of the finger capacitor Cf is 10 fF, the voltage difference dVet is approximately 90 mV. Thus, when the capacitance value of the finger capacitor Cf is getting bigger, the sensitivity of the touch sensing device 100 is getting higher. However, in actual application, when the touch sensing device 100 is integrated into a liquid crystal display panel, the actual detection electrode 120 cannot be too large due to the consideration of the aperture ratio of the liquid crystal display and the resolution and visual feeling of the liquid crystal display panel, meaning that the capacitance value Cf of the finger capacitor is approximately smaller than or equal to 1 fF. Typically, the capacitance value Cgds of the pre-charge transistor 110 or the amplifier transistor 130 is approximately to be tens of fF, and thus the touch sensing device 100 has the drawback of insufficient sensitivity. Therefore it is desired for the above touch sensing device to be improved.

### SUMMARY OF THE INVENTION

An object of the present invention is to provide a touch sensing unit and a liquid crystal display panel with the same for effectively improving sensing accuracy of touch position.

Another object of the present invention is to provide a touch sensing unit and a liquid crystal display panel with the same having a simple hardware architecture. An LCD panel integrated with the touch sensing unit of the present invention is provided with the advantages of better aperture ratio and quality.

In one aspect of the invention, there is provided a touch sensing unit, which comprises a detection electrode, a switch and a boosting and discharging unit. The detection electrode is used for detecting a touch from an external object. The switch is connected to the detection electrode for generating a detection voltage. The boosting and discharging unit is connected to the detection electrode and the switch for discharging the detection electrode or boosting voltage of the detection electrode.

In another aspect of the invention, there is provided a liquid crystal display panel with the touch sensing units, which comprises a plurality of scanning lines, a plurality of touch sensing scanning lines, a plurality of data lines, a plurality of pixels, a plurality of thin-film transistors and a plurality of touch sensing units. The plurality of scanning lines are arranged according to a first direction. The plurality of touch sensing scanning lines are arranged according to the first direction. The plurality of data lines are arranged according to a second direction. Each thin-film transistor of the plurality of thin-film transistors has a gate connected to a corresponding scanning line of the plurality of scanning lines, a source connected to a corresponding data line of the plurality of data lines, and a drain connected to a corresponding pixel of the plurality of pixels. Each touch sensing unit of the plurality of touch sensing units has one terminal connected to a corresponding touch sensing scanning line of the plurality of touch sensing scanning lines, and the other terminal connected to a corresponding data line of the plurality of data lines;

Other objects, advantages, and novel features of the invention will become more apparent from the following detailed description when taken in conjunction with the accompanying drawings.

### BRIEF DESCRIPTION OF THE DRAWINGS

FIG. 1 is a circuit diagram of a prior touch sensing device;

FIG. 2 is a schematic diagram showing the voltage sensed by the known touch sensing device;

FIG. 3 is a schematic diagram of the simulation of the voltage sensed by the prior touch sensing device;

FIG. 4 is a schematic diagram of a touch sensing unit of the present invention;

FIG. 5 is a circuit diagram of an embodiment of the touch sensing unit in accordance with the present invention;

FIG. 6 and FIG. 7 are the equivalent circuit diagrams of FIG. 5 of the present invention;

FIG. 8 is a schematic diagram of the sensing control signal of the present invention;

FIG. 9 is a schematic diagram of the simulation of the voltage sensed by the touch sensing unit in the present invention;

FIG. 10 is a circuit diagram of the touch sensing unit in accordance with another embodiment of the present invention;

FIG. 11 is a circuit diagram of the touch sensing unit in accordance with a further embodiment of the present invention;

FIG. 12 is a schematic diagram of a measured voltage of prior art;

FIG. 13 is a schematic diagram of a measured voltage of the present invention;

FIG. 14 is a schematic diagram of another measured voltage of the present invention; and

FIG. 15 is a schematic diagram of a liquid crystal display panel with the touch sensing unit in accordance with the present invention.

### DETAILED DESCRIPTION OF THE PREFERRED EMBODIMENT

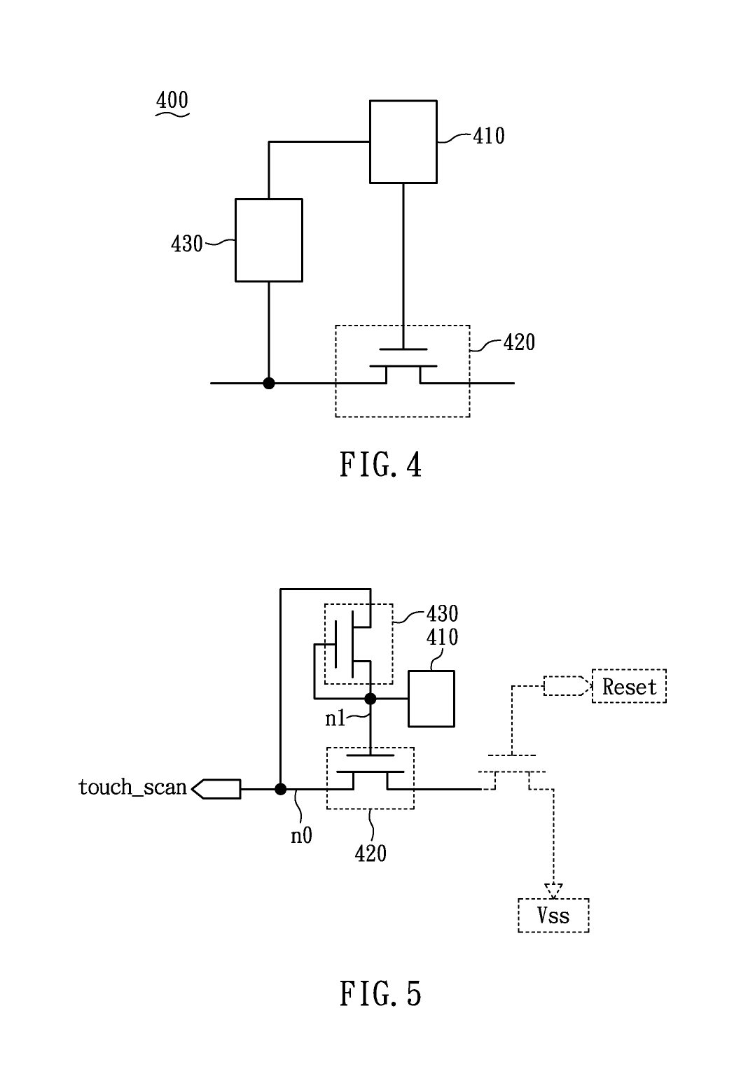

FIG. 4 is a schematic diagram of a touch sensing unit 400 of the present invention. The touch sensing unit comprises a detection electrode 410, a switch 420, a boosting and discharging unit 430 and a sensing control signal source 440.

The detection electrode 410 is provided for detecting a touch from an external object.

The switch 420 is connected to the detection electrode 410 for generating a detection voltage. The switch 420 is a first MOS transistor 420 having a gate connected to the detection electrode 410.

The boosting and discharging unit 430 is connected to the detection electrode 410 and the switch 420 for discharging the detection electrode 410 or boosting voltage of the detection electrode 410.

The sensing control signal source 440 is connected to the switch 420 for providing a discharging reference voltage or a sensing reference voltage, wherein the discharging reference voltage has a voltage level smaller than that of the sensing reference voltage.

FIG. 5 is a circuit diagram of an embodiment of the touch sensing unit 400 in accordance with the present invention. As shown in FIG. 5, the boosting and discharging unit 430 is a second MOS transistor 430 configured to be a diode. The gate and drain of the second MOS transistor 430 are connected to the detection electrode 410, and the source thereof is connected to the switch 420 for receiving a sensing control signal (touch_scan).

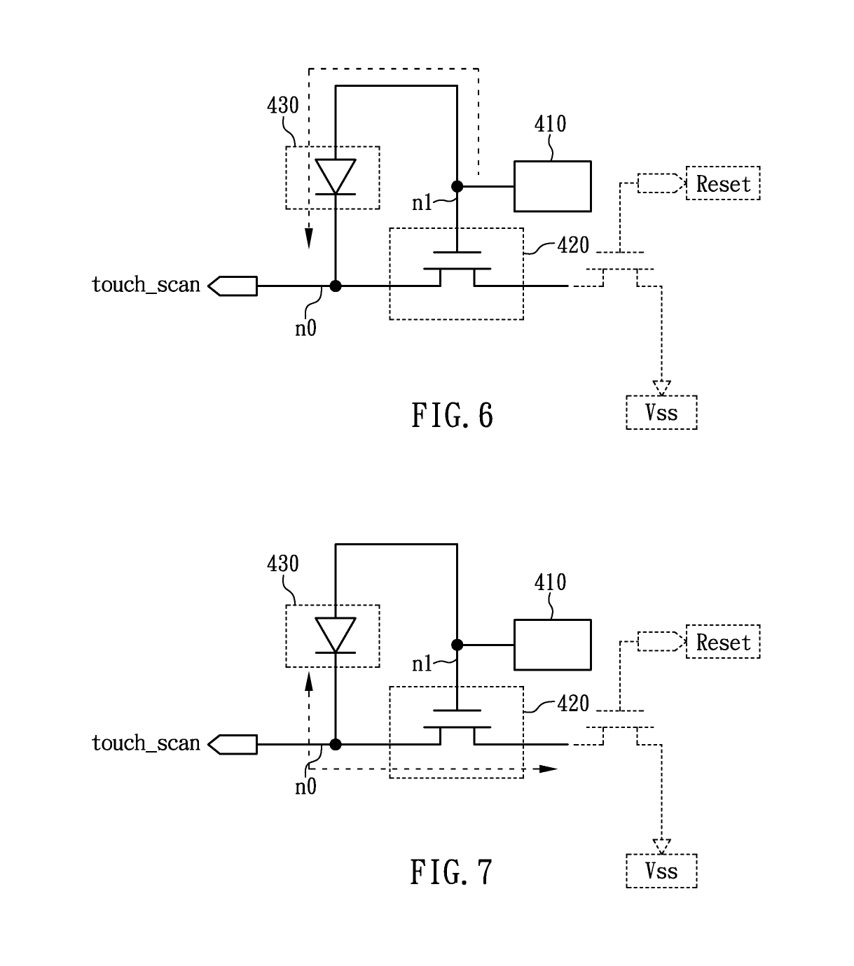

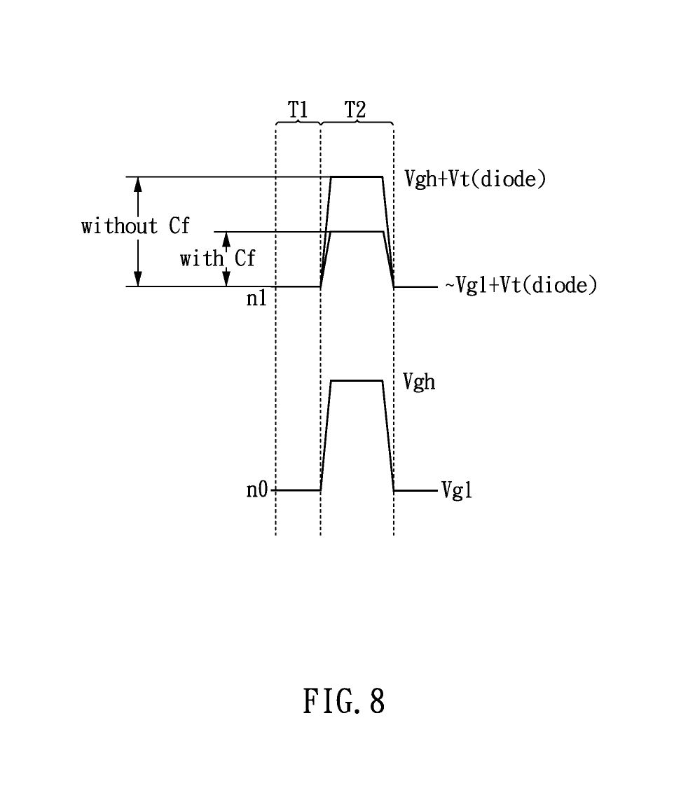

FIG. 6 and FIG. 7 are the equivalent circuit diagrams of FIG. 5 of the present invention. FIG. 8 is a schematic diagram of the sensing control signal (touch_scan) of the present invention. The sensing control signal (touch_scan) is selectively to be a low potential or a high potential, in which the low potential has a voltage level smaller than that of the high potential, wherein FIG. 6 is the equivalent circuit diagram of FIG. 5 when the sensing control signal is the low potential and FIG. 7 is the equivalent circuit diagram of FIG. 5 when the sensing control signal is the high potential.

As shown in FIG. 6, when the sensing control signal (touch_scan) is the low potential, the second MOS transistor 430 is turned on as a diode for discharging the detection electrode 410 and the second MOS transistor 430 is operated as a diode.

As shown in FIG. 7, when the sensing control signal (touch_scan) is the high potential, the second MOS transistor 430 is turned off for boosting the voltage of the detection electrode 410 by a coupling effect of capacitor, and the second MOS transistor 430 is operated as an off diode for providing a capacitor in reverse direction.

As shown in FIG. 8, at time T1, when the sensing control signal (touch_scan) is the low potential, the sensing control signal (touch_scan) is deemed to be a reset state for resetting a node n1 voltage to a voltage Vgl+Vt(diode), in which Vgl is the low potential of the sensing control signal (touch_scan). The second MOS transistor 430, used as a diode, has the threshold voltage represented by Vt(diode).

At time T2, when the sensing control signal (touch_scan) is the high potential, the sensing control signal (touch_scan) is deemed to be a sensing state. The sensing control signal (touch_scan) switches from the low potential Vgl to the high potential Vgh. The capacitors related to the node n1 include a capacitor Cgd1 between the gate and drain of the second MOS transistor 430, a capacitor Cgd2 between the gate and drain of the first MOS transistor 420, and a finger capacitor Cf generated when the finger touches the glass surface. Therefore, the voltage of the node n1 can be represented as:

(Vgh−Vgl)*[(Cgd1+Cgd2)/(Cgd1+Cgd2+Cf)]+Vgl+Vt(diode).

When there is no finger touching, the finger capacitor is 0 and therefore the voltage of the node n1 at this time can be represented as Vgh+Vt(diode).

Therefore, regardless of the finger touching, the voltage difference of the node n1 can be represented as:

(Vgh−Vgl)*[Cf/(Cgd1+Cgd2+Cf)]. (2)

It is known from equation (2) that, for practical design, the desired voltage difference can be obtained by adjusting the proportion of Cf and Cgd1+Cgd2 in the invention. Furthermore, by measuring the difference of the current which flows through the first MOS transistor 420 before and after the finger touching, it is able to determine whether there is a finger touching or not. In addition, by comparing equation (1) and equation (2), it is known that the voltage difference dVet in prior circuit is:

dVet=ΔV*{Cf*(Cc+Cs2)/[(Cc+Cs1+Cs2+Cf)*(Cc+Cs1+Cs2)]},

where ΔV=(Vgh−Vgl). However, in the invention, the voltage difference dVet is:

dVet=ΔV*[Cf/(Cgd1+Cgd2+Cf)].

In practical application, the finger capacitor Cf is approximately 1 fF, and the capacitors Cgd1 and Cgd2 between the gate and drain of the MOS transistors 420, 430 are larger than the finger capacitor Cf by an order of magnitude, approximately tens of fF. Therefore, it will be understood by comparing equation (1) and equation (2) that the effect of the capacitor Cgd between the gate and drain of the transistor in prior circuit is larger than that of the present invention, and thus the sensitivity of the finger capacitor Cf in prior circuit is worse than that in the present invention.

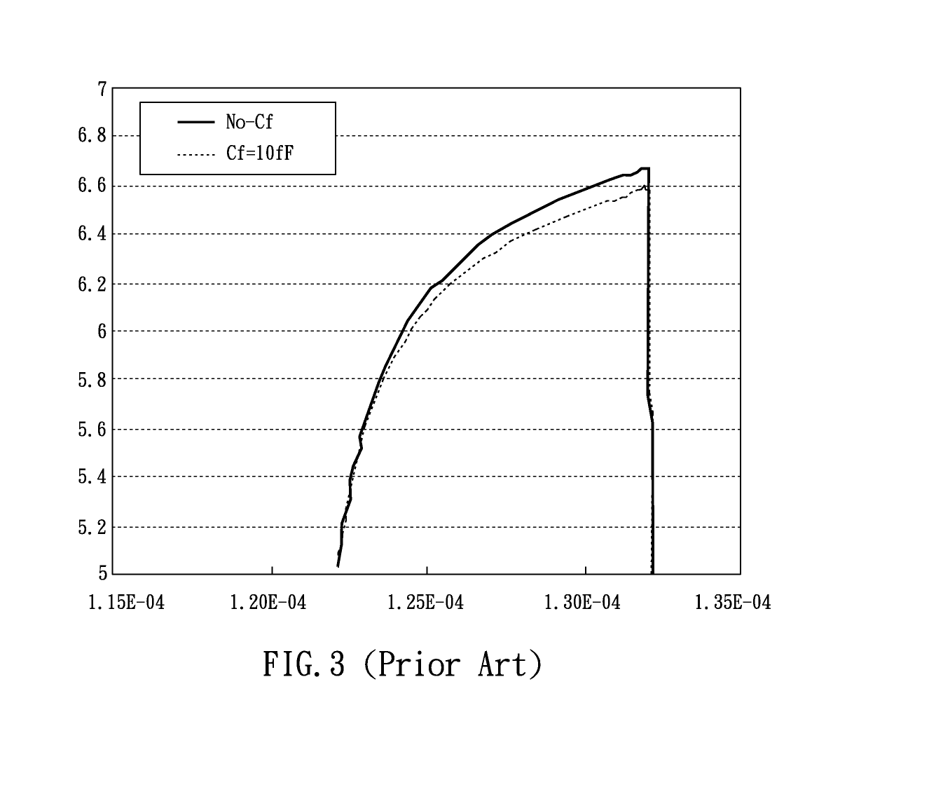

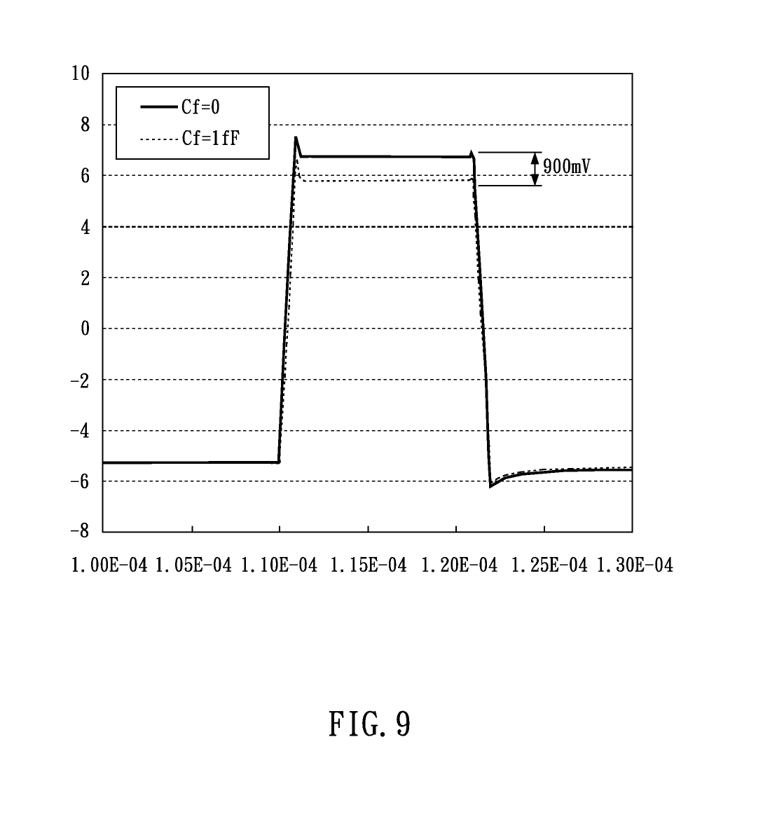

The same simulation conditions of Vgh=10V, Vgl=−5V, Cgd1=0.02 pF, Cgd2=0.02 pF, and width/length ratio (W/L) of the transistor=20/10 are used for simulation by Spice. FIG. 9 is a schematic diagram of the simulation of the voltage sensed by the touch sensing unit 400 in the present invention. It can be understood by comparing FIG. 3 and FIG. 9, that the finger capacitor Cf needs to be 10 fF for the prior circuit in order to have a voltage variation of 90 mV. However, when the finger capacitor Cf is 1 fF in the present invention, there is a voltage variation of 900 mV. Namely, the circuit of the present invention has a better sensitivity than that of prior circuit and thus an accurate touch sensing can be performed.

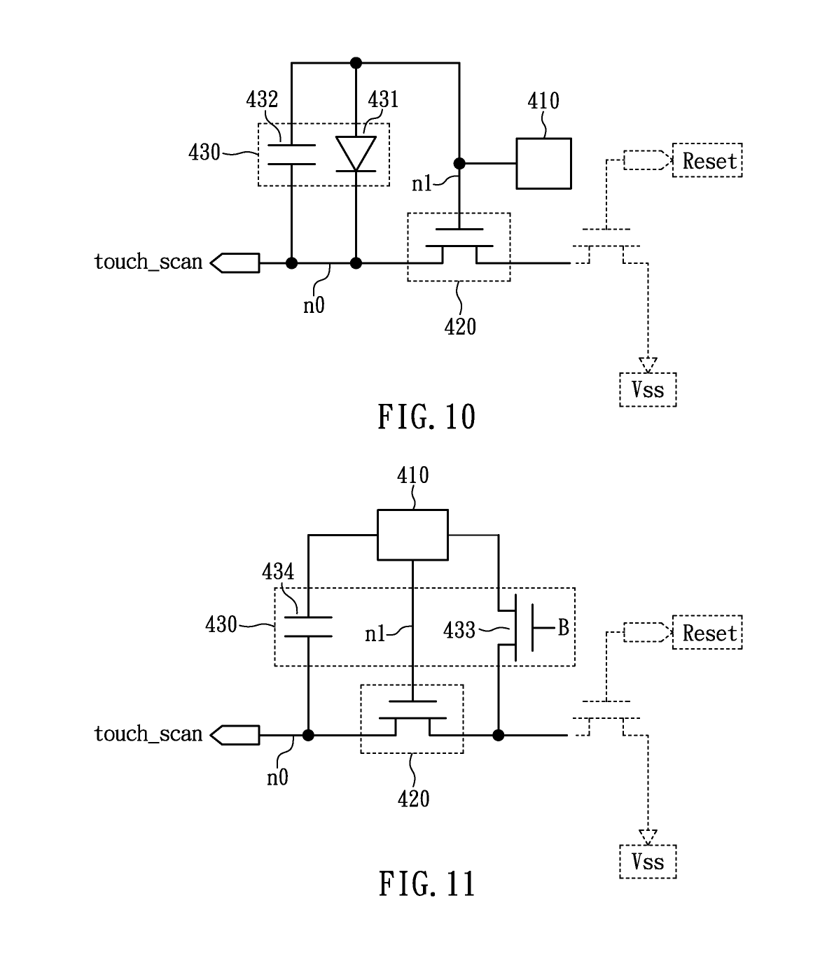

FIG. 10 is a circuit diagram the touch sensing unit 400 in accordance with another embodiment of the present invention, wherein the boosting and discharging unit 430 is a diode 431. The anode of the diode 431 is connected to the detection electrode 410 and the cathode thereof is connected to the switch 420 for receiving a sensing control signal (touch_scan). The sensing control signal is selectively to be a low potential or a high potential, in which the low potential has a voltage level smaller than that of the high potential.

When the sensing control signal (touch_scan) is the low potential, the diode 431 is turned on for discharging the detection electrode 410. When the sensing control signal (touch_scan) is the high potential, the diode 431 is turned off for boosting the voltage of the detection electrode 410 by a coupling effect of capacitor. The capacitor is deemed as depletion or junction capacitance of the diode 431 being turned off.

The boosting and discharging unit 430 further comprises a capacitor 432 having two terminals connected to the anode and the cathode of the diode 431 for increasing capacitance value between the detection electrode 410 and the sensing control signal (touch_scan) when the diode 431 is turned off. The operation of this embodiment is the same as that of FIG. 5 and thus a detailed description therefor is deemed unnecessary.

FIG. 11 is a circuit diagram of the touch sensing unit 400 in accordance with a further embodiment of the present invention. The boosting and discharging unit 430 is composed of a third MOS transistor 433 and a capacitor 434, and the third MOS transistor 433 and the capacitor 434 are connected to the detection electrode 410 and the switch 420. The switch 420 is a first MOS transistor. The third MOS transistor 433 has a gate for receiving a reset signal (B), a drain connected to the detection electrode 410, and a source connected to the switch 420. The capacitor 434 has one terminal connected to the detection electrode 410, and the other terminal connected to the switch 420 for receiving a sensing control signal (touch_scan). The sensing control signal (touch_scan) is selectively to be a low potential or a high potential, in which the low potential has a voltage level smaller than that of the high potential.

When the sensing control signal (touch_scan) is the low potential and the reset signal B enables the third MOS transistor 433, the third MOS transistor 433 is turned on for discharging the detection electrode 410 via the third MOS transistor 433 and the first MOS transistor 420. When the sensing control signal (touch_scan) is the high potential and the reset signal B disables the third MOS transistor 433, the third MOS transistor 433 is turned off so that the sensing control signal (touch_scan) boosts the voltage of the detection electrode 410 via the capacitor 434. The operation of this embodiment is the same as that of FIG. 5 and thus a detailed description therefor is deemed unnecessary.

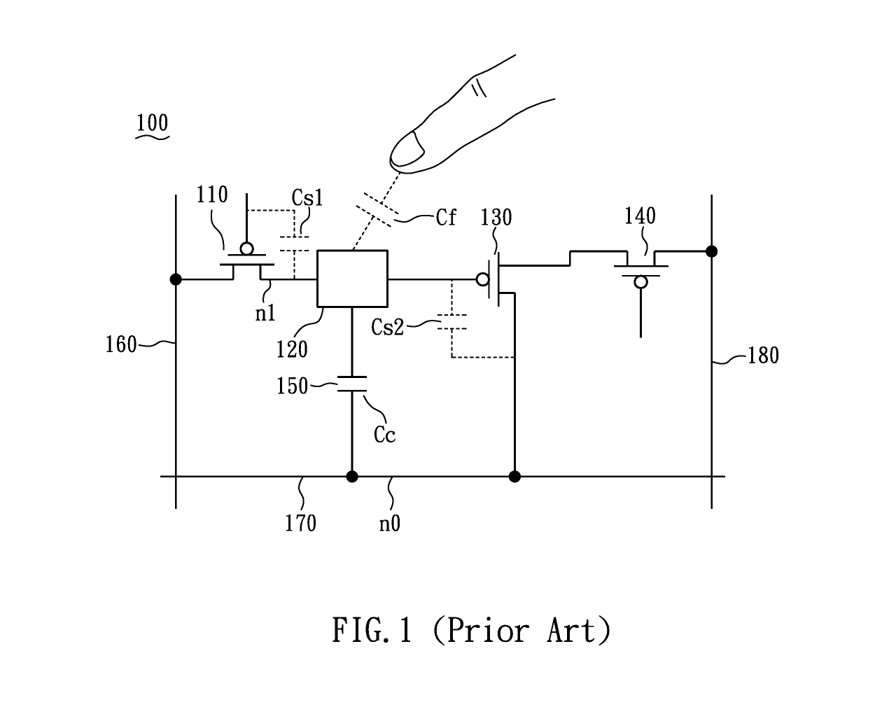

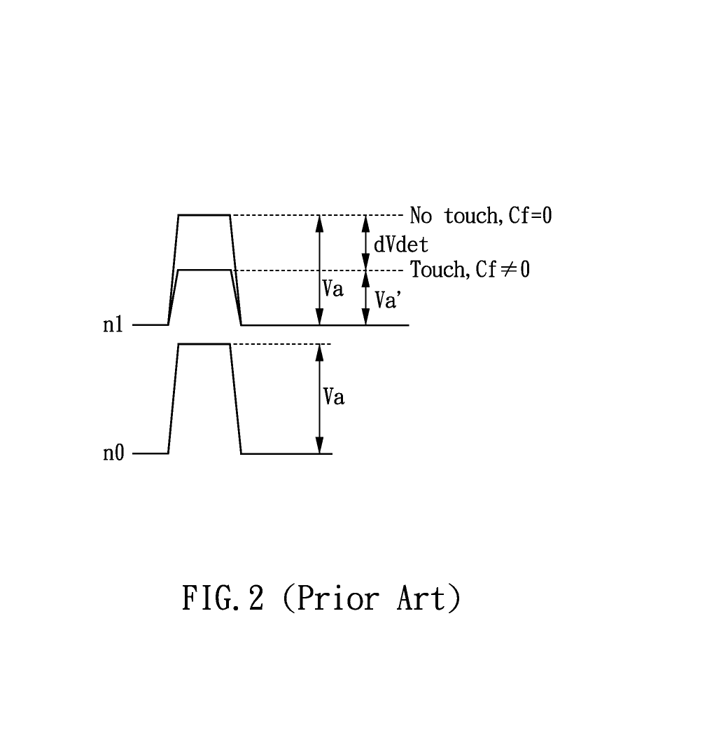

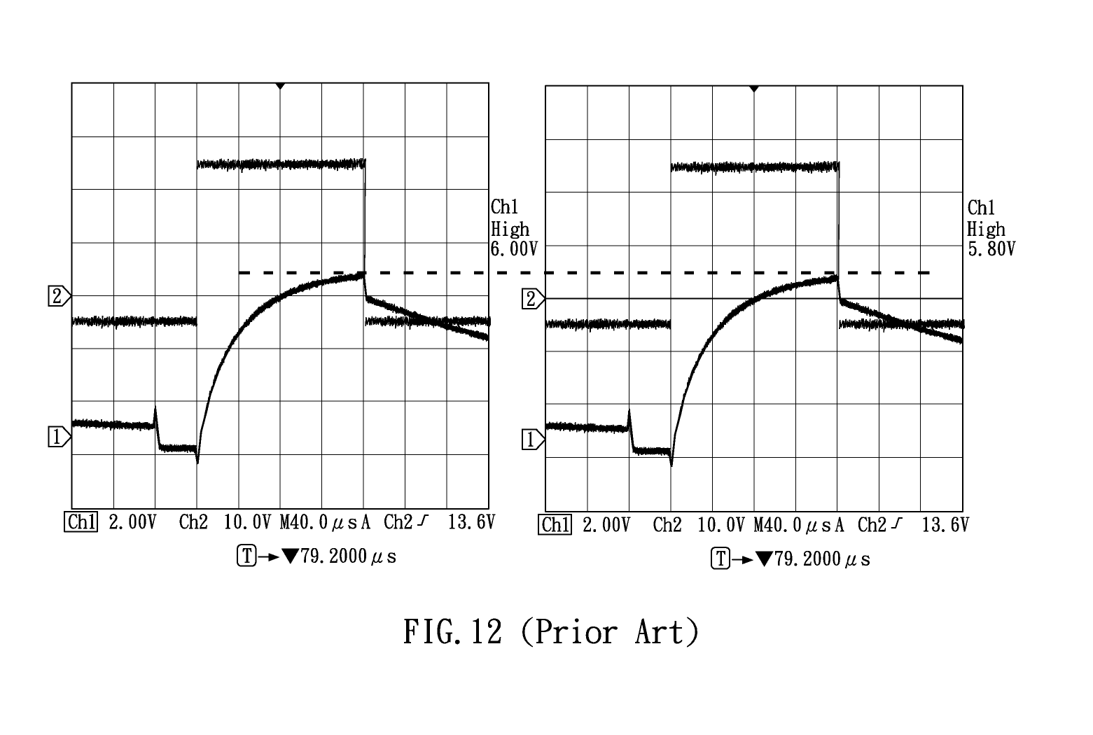

FIG. 12 is a schematic diagram of a measured voltage in prior art that uses an oscilloscope to measure the voltage of the circuit of FIG. 1. The left side of FIG. 12 is the measured voltage when no finger approaches and the right side of FIG. 12 is the measured voltage when a finger approaches.

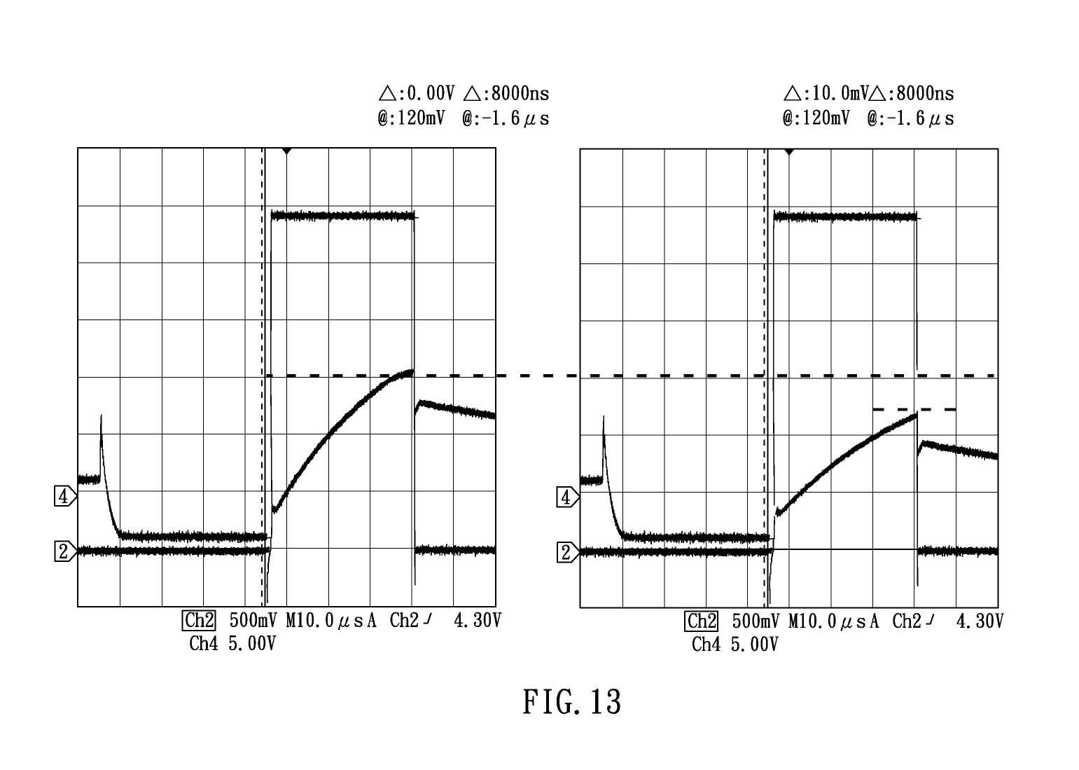

FIG. 13 is a schematic diagram of a measured voltage of the present invention that uses an oscilloscope to measure the voltage of the circuit of FIG. 5. The left side of FIG. 13 is the measured voltage when no finger approaches and the right side of FIG. 13 is the measured voltage when a finger approaches.

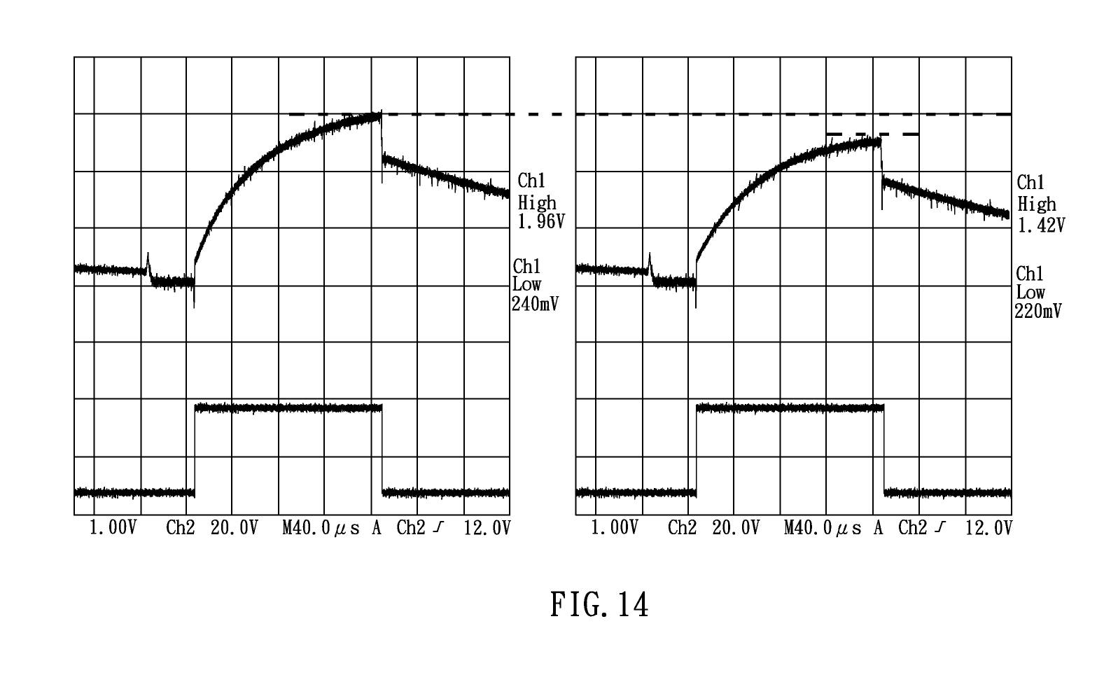

FIG. 14 is a schematic diagram of another measured voltage of the present invention that uses an oscilloscope to measure the voltage of the circuit of FIG. 10. The left side of FIG. 14 is the measured voltage when no finger approaches and the right side of FIG. 14 is the measured voltage when a finger approaches.

It will be understood from FIG. 12, FIG. 13 and FIG. 14 that, no matter whether the finger touches the circuit of the invention or not, the voltage difference of the node n1 is larger than that of the node n1 of prior art, indicating that the present invention is able to accurately detect presence of the finger.

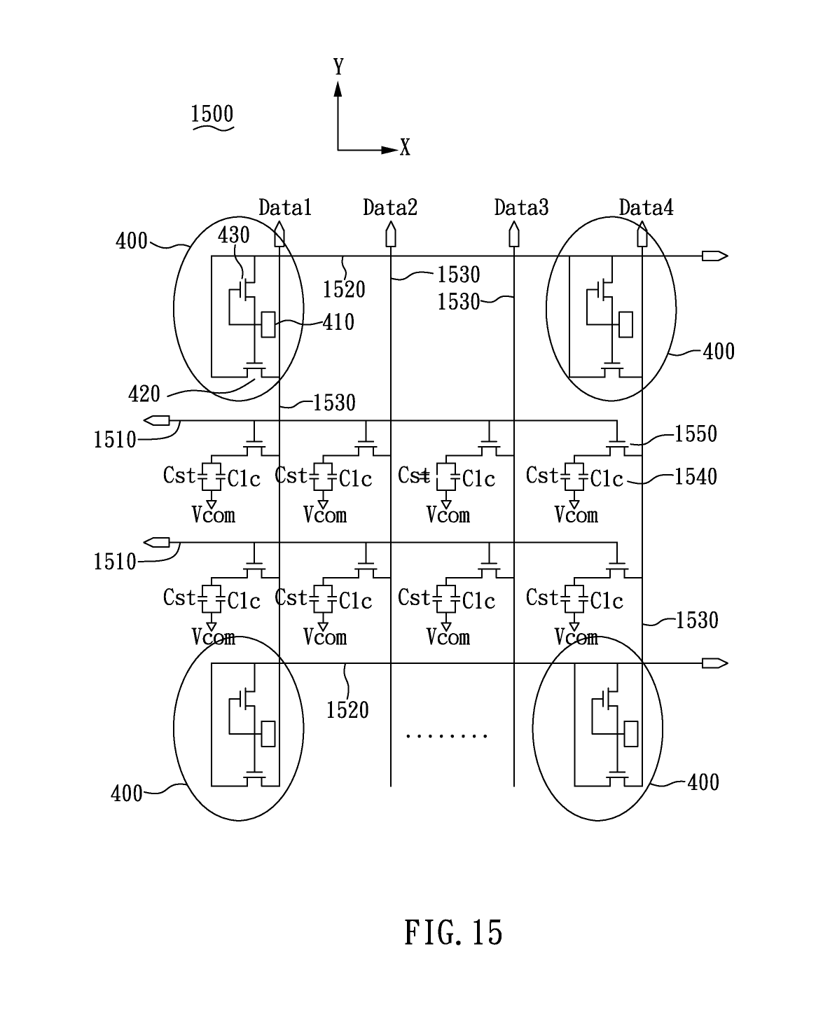

FIG. 15 is a schematic diagram of a liquid crystal display panel 1500 with the touch sensing unit, which comprises: a plurality of scanning lines 1510, a plurality of touch sensing scanning lines 1520, a plurality of data lines 1530, a plurality of pixels 1540 and a plurality of touch sensing units 400.

The plurality of scanning lines 1510 are arranged according to a first direction (X direction). The plurality of touch sensing scanning lines 1520 are arranged according to the first direction. The plurality of data lines are arranged according to a second direction (Y direction). The first direction is substantially vertical to the second direction.

The plurality of pixels 1540 are connected to the plurality of scanning lines 1510 and the plurality of data lines 1530.

Each of the plurality of touch sensing units 400 has one terminal connected to a corresponding touch sensing scanning line of the plurality of touch sensing scanning lines, and the other terminal is connected to a corresponding data line of the plurality of data lines.

Each of the plurality of touch sensing units 400 comprises a detection electrode 410, a switch 420, a boosting and discharging unit 430 and a sensing control signal source 440.

The detection electrode 410 is provided for detecting a touch from an external object. The switch 420 is a first MOS transistor having a gate connected to the detection electrode 410, a drain connected to the corresponding touch sensing scanning line of the plurality of touch sensing scanning lines, and a source electrode connected to the corresponding data line of the plurality of data lines.

The boosting and discharging unit 430 is connected to the detection electrode 410 and the corresponding touch sensing scanning line of the plurality of touch sensing scanning lines for discharging the detection electrode or boosting the voltage of the detection electrode. The sensing control signal source 440 is connected to the switch 420 for providing a discharging reference voltage or a sensing reference voltage, wherein the discharging reference voltage has a voltage level smaller than that of the sensing reference voltage.

By designing a sensor array based on the circuit of the present invention inside a display panel, it is able to detect the touch position of a finger via the circuit operation of the sensor array.

It can be understood from the above description that the present invention uses capacitances Cgd, Cgs of transistor as coupling capacitors to eliminate the need of designing additional coupling capacitor in the circuit, and further integrates the coupling capacitor 150 and read transistor 140 in prior circuit into the first transistor 420 and integrates the pre-charge transistor 110, pre-charge line 160 and pre-charge line 160 into the boosting and discharging unit 430. The architecture in prior circuit needs three transistors and a coupling capacitor, but the circuit architecture of the present invention only needs two transistors while no coupling capacitor is required. Thus, when the touch sensing units of the present invention are integrated into an LCD panel, the advantages of having better aperture ratio and quality can be provided.

Furthermore, when the capacitance value Cf of the finger capacitor in prior circuit is 10 fF, the voltage difference is only 90 mV. However, in the present invention, when the capacitance value Cf of the finger capacitor is 1 fF, a voltage difference of 900 mV can be achieved, so as to provide a better sensitivity than prior circuit.

Although the present invention has been explained in relation to its preferred embodiment, it is to be understood that many other possible modifications and variations can be made without departing from the spirit and scope of the invention as hereinafter claimed.

What is claimed is:

1. A touch sensing unit comprising:
a detection electrode for detecting a touch from an external object;
a switch connected to the detection electrode for generating a detection voltage; and
a boosting and discharging unit connected to the detection electrode and the switch for discharging the detection electrode or boosting voltage of the detection electrode.

2. The touch sensing unit of claim 1, wherein the switch is a first MOS transistor having a gate connected to the detection electrode.

3. The touch sensing unit of claim 2, further comprising:
a sensing control signal source connected to the switch for providing a discharging reference voltage or a sensing reference voltage;
wherein the discharging reference voltage has a voltage level smaller than that of the sensing reference voltage.

4. The touch sensing unit of claim 2, wherein the boosting and discharging unit is a second MOS transistor configured to be a diode.

5. The touch sensing unit of claim 4, wherein the second MOS transistor has the gate and drain connected to the detection electrode and the source connected to the switch for receiving a sensing control signal;
the sensing control signal is selectively to be a low potential or a high potential, in which the low potential has a voltage level smaller than that of the high potential.

6. The touch sensing unit of claim 5, wherein when the sensing control signal is the low potential, the second MOS transistor is turned on for discharging the detection electrode.

7. The touch sensing unit of claim 6, wherein when the sensing control signal is the high potential, the second MOS transistor is turned off for boosting the voltage of the detection electrode by a coupling effect of capacitor.

8. The touch sensing unit of claim 2, wherein the boosting and discharging unit is a diode.

9. The touch sensing unit of claim 8, wherein the diode has an anode connected to the detection electrode and a cathode connected to the switch for receiving a sensing control signal;
the sensing control signal is selectively to be a low potential or a high potential, in which the low potential has a voltage level smaller than that of the high potential.

10. The touch sensing unit of claim 9, wherein when the sensing control signal is the low potential, the diode is turned on for discharging the detection electrode.

11. The touch sensing unit of claim 10, wherein when the sensing control signal is the high potential, the diode is turned off for boosting the voltage of the detection electrode by a coupling effect of capacitor.

12. The touch sensing unit of claim 2, wherein the boosting and discharging unit is composed of a third MOS transistor and a capacitor, and the third MOS transistor and the capacitor are connected to the detection electrode and the switch.

13. The touch sensing unit of claim 12, wherein the third MOS transistor has a gate for receiving a reset signal, a drain connected to the detection electrode, and a source connected to the switch, and the capacitor has one terminal connected to the detection electrode, and the other terminal connected to the switch for receiving a sensing control signal;
the sensing control signal is selectively to be a low potential or a high potential, in which the low potential has a voltage level smaller than that of the high potential.

14. The touch sensing unit of claim 13, wherein when the sensing control signal is the low potential and the reset signal enables the third MOS transistor, the third MOS transistor is turned on for discharging the detection electrode via the third MOS transistor and the first MOS transistor.

15. The touch sensing unit of claim 14, wherein when the sensing control signal is the high potential and the reset signal disables the third MOS transistor, the third MOS transistor is turned off so that the sensing control signal boosts the voltage of the detection electrode via the capacitor.

16. A liquid crystal display panel with touch sensing unit comprising:
a plurality of scanning lines arranged according to a first direction;
a plurality of touch sensing scanning lines arranged according to the first direction;
a plurality of data lines arranged according to a second direction;
a plurality of pixels connected to the plurality of scanning lines and the plurality of data lines; and
a plurality of touch sensing units, each of the touch sensing units having one terminal connected to a corresponding touch sensing scanning line of the plurality of touch sensing scanning lines, and the other terminal connected to a corresponding data line of the plurality of data lines;
wherein each of the plurality of touch sensing units comprises:
a detection electrode for detecting a touch from an external object;
a switch, which is a first MOS transistor having a gate connected to the detection electrode, a drain connected to the corresponding touch sensing scanning line of the plurality of touch sensing scanning lines, and a source connected to the corresponding data line of the plurality of data lines; and
a boosting and discharging unit connected to the detection electrode and the corresponding touch sensing scanning line of the plurality of touch sensing scanning lines for discharging the detection electrode or boosting the voltage of the detection electrode.

17. The liquid crystal display panel of claim 16, wherein each of the plurality of touch sensing units further comprises:
a sensing control signal source connected to the switch for providing a discharging reference voltage or a sensing reference voltage;
wherein the discharging reference voltage has a voltage level smaller than that of the sensing reference voltage.
